(19) United States
(12) Patent Application Publication
(10) Pub. No.: US 2002/0024000 A1
(43) Pub. Date: Feb. 28, 2002

(54) Photosensor having shading member between optical lens and light sensing element

(76) Inventor: Takeshi Tsukamoto, Okazaki-city (JP)

Correspondence Address: LAW OFFICE OF DAVID G POSZ, 2000 L STREET, N.W., SUITE 200, WASHINGTON, DC, 20036, US

(21) Appl. No.: 09/922,802

(22) Filed: Aug. 7, 2001

(30) Foreign Application Priority Data
Aug. 8, 2000 (JP) 2000-239859

(51) Int. Cl. G01C 21/02; G01J 1/20

(52) U.S. Cl. 250/203.1

(57) ABSTRACT

A sensor chip is arranged on a top of a housing. An optical lens having a recess in a lower surface thereof is arranged above the sensor chip. A shading plate having a through hole is arranged between the lens and the sensor chip. A shape and size of an opening of the recess of the lens are substantially the same as a shape and size of a top opening of the through hole of the shading plate. An outer peripheral edge of the opening of the recess of the lens is vertically substantially aligned with an outer peripheral edge of the top opening of the through hole of the shading plate. Furthermore, the lower surface of the optical lens is engaged with a top surface of the shading plate.

### CROSS REFERENCE TO RELATED APPLICATION

This application is based on and incorporates herein by reference Japanese Patent Application No. 2000-239859 filed on Aug. 8, 2000.

### BACKGROUND OF THE INVENTION

1. Field of the Invention

The present invention relates to a photosensor, such as a sunlight sensor used in a vehicle air conditioning system.

2. Description of Related Art

A sunlight sensor is used for independently air conditioning (zone air conditioning) the left and right sides of a passenger compartment of a vehicle, as disclosed, for example, in Japanese Unexamined Patent Publication No. 11-337405. It has been demanded that the sunlight sensor used for the zone air conditioning accurately senses a direction of the sun. More specifically, it has been demanded that the sunlight sensor accurately senses the direction of the sun even when an elevation angle of the sun is relatively low.

### SUMMARY OF THE INVENTION

Accordingly, it is an objective of the present invention to provide a sunlight sensor that has an improved light sensing capability.

To achieve the objective of the present invention, there is provided a photosensor including a housing, a light sensing element, an optical lens and a shading member. The light sensing element is arranged on a top surface of the housing. The optical lens is arranged above the light sensing element. The optical lens includes a recess having an opening in a lower surface of the optical lens. The optical lens guides light entered therein toward the light sensing element through the recess. The shading member is arranged between the light sensing element and the optical lens. The shading member has a through hole penetrating therethrough. The light exited from the optical lens is guided through the through hole of the shading member toward the light sensing element. An outer peripheral edge of the opening of the recess of the optical lens is vertically substantially aligned with an outer peripheral edge of a top end opening of the through hole of the shading member.

### BRIEF DESCRIPTION OF THE DRAWINGS

The invention, together with additional objectives, features and advantages thereof, will be best understood from the following description, the appended claims and the accompanying drawings in which:

FIG. 1 is a plan view of a vehicle sunlight sensor according to one embodiment of the present invention;

FIG. 2 is a cross-sectional view along line II-II in FIG. 1;

FIG. 3 is a plan view of a sensor chip of the sunlight sensor according to the embodiment;

FIG. 4 is a schematic perspective view of the sensor chip;

FIG. 5A is a plan view of a shading plate of the sunlight sensor according to the embodiment;

FIG. 5B is a cross-sectional view along line VB-VB in FIG. 5A;

FIG. 6 is a schematic diagram showing an electrical arrangement of an automatic air conditioning system according to the present embodiment; and

FIG. 7 is a schematic view showing an optical system according to the present embodiment.

### DETAILED DESCRIPTION OF THE INVENTION

One embodiment of the present invention will now be described with reference to the accompanying drawings.

A vehicle sunlight sensor acting as a photosensor according to the present embodiment is used, for example, in a vehicle automatic air conditioning system. This automatic air conditioning system allows independent control of a temperature and the amount of air directed toward a left front passenger and a temperature and the amount of air directed toward a right front passenger in a passenger compartment of a vehicle based on an output of the sunlight sensor.

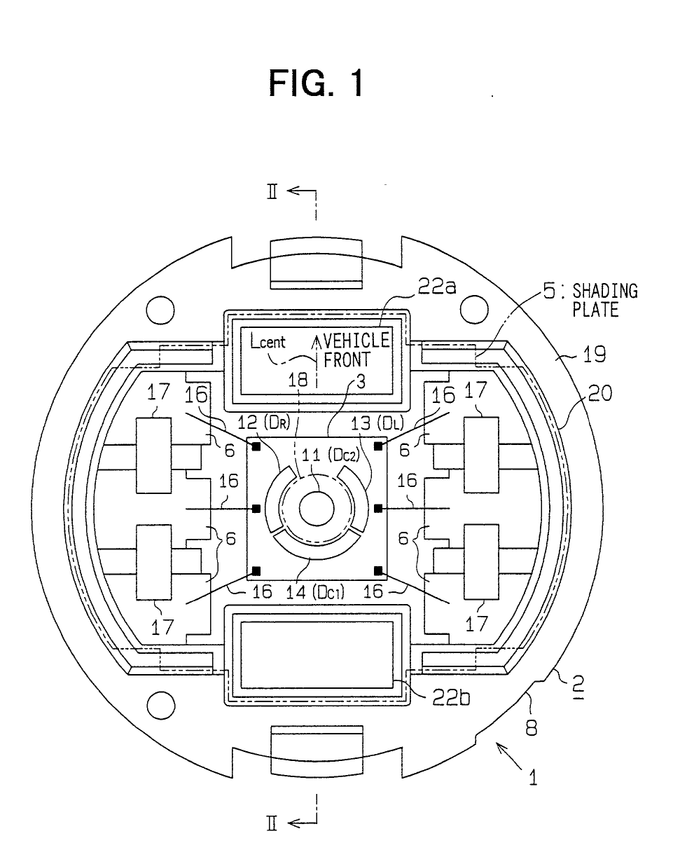

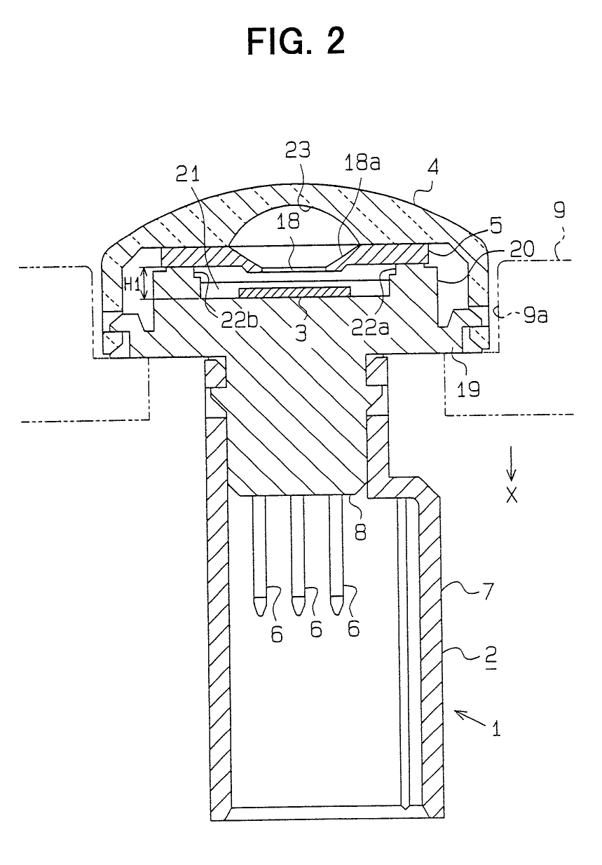

With reference to FIGS. 1 and 2, an optical lens (filter) 4 and a shading plate 5 shown in FIG. 2 are removed from the sunlight sensor 1 shown in FIG. 1 for the sake of clarity. However, for ease of understanding, the location of the shading plate 5 is indicated with a dot-dot-dash line in FIG. 1.

With reference to FIG. 2, the sunlight sensor 1 includes a housing 2, a sensor chip 3, the optical lens 4, the shading plate (slit plate) 5 and terminals 6. The housing 2 includes a case 7 and a holder 8. The case 7 and the holder 8 are both made of a synthetic resin material. The case 7 is cylindrical and is installed in the vehicle in such a manner that a longitudinal axis of the case 7 extends in a vertical direction of the vehicle. The holder 8 is fitted within a top end of the case 7. The case 7 can be used as a common component, and the holder 8 (a light sensing element and a connector) can be replaced with a desired one depending on a sensor specification.

As shown in FIG. 2, the vehicle sunlight sensor 1 is installed within a sensor receiving hole 9a formed in a vehicle dash panel 9 by inserting the sunlight sensor 1 in a direction of X in FIG. 2.

A sensor chip 3 is centrally arranged on a top surface of the holder 8. The terminals 6 acting as output terminals for outputting sensor signals are insert molded within the holder 8. One end of each terminal 6 protrudes from a lower surface of the holder 8, and the other end of the same terminal 6 is exposed from the top surface of the holder 8, as shown in FIG. 1.

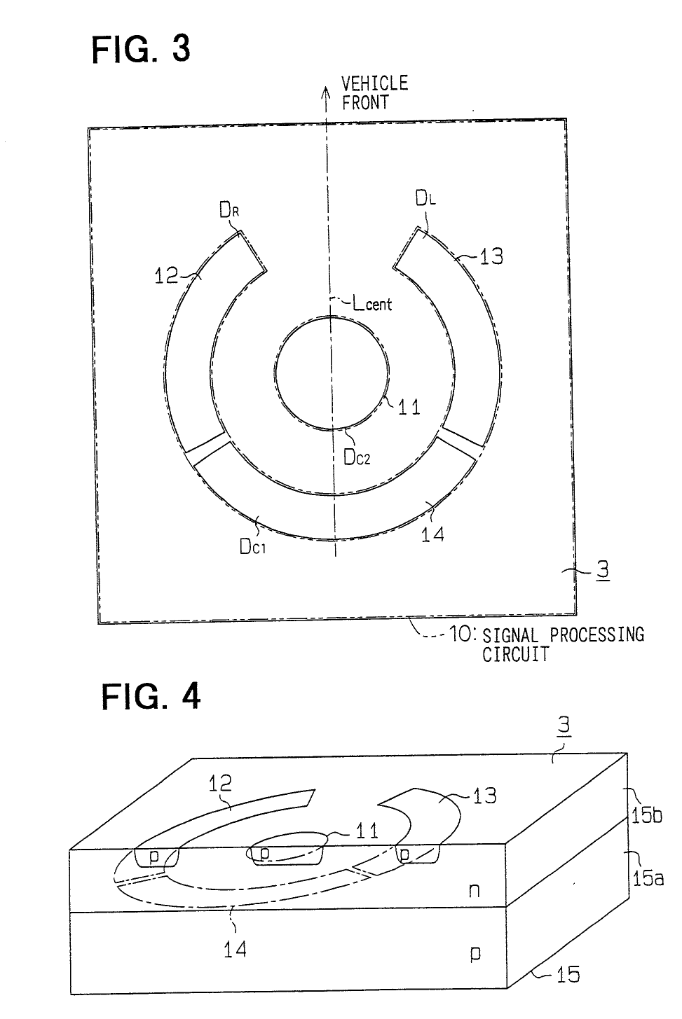

With reference to FIGS. 1 and 3, in the sensor chip 3, a right-incidient light sensing photodiode DR for sensing incident light from the right side of the vehicle is arranged on a left side of a reference axis Lcent that indicates a reference direction of zero degrees, and a left-incidient light sensing photodiode DL for sensing incident light from the left side of the vehicle is arranged on a right side of the reference axis Lcent. Furthermore, central sensing photodiodes DC1, DC2 are arranged on the reference axis Lcent. Each photodiode DR, DL, DC1, DC2 outputs a sensor signal corresponding to the amount (light intensity) of light impinged thereon.

Further details of the sensor chip 3 will be described with reference to FIGS. 3 and 4. The sensor chip 3 is an optical integrated circuit (IC) that includes a signal processing circuit 10 in addition to the photodiodes DR, DL, DC1, DC2. More specifically, the sensor chip 3 includes a circular light sensing area 11 and arcuate light sensing areas 12, 13, 14 surrounding the circular light sensing area 11. Each area 11-14 is electrically insulated from its surroundings. More specifically, as shown in FIG. 4, a silicon substrate 15 includes a p-type silicon substrate 15a and an n-type epitaxial layer 15b provided on the p-type silicon substrate 15a. P-type regions 11-14 are provided on a top surface layer of the n-type epitaxial layer 15b. The p-type region 12 constitutes the photodiode DR, and the p-type region 13 constitutes the photodiode DL. The p-type regions 14, 11 constitute the photodiodes DC1, DC2, respectively. Thus, each p-type region 11-14 acts as the light sensing portion of the sensor chip 3. As indicated with a dot-dot-dash line in FIG. 3, a signal processing circuit 10 is formed (integrated) in the sensor chip 3 around the light sensing portions 11-14.

On the other hand, as shown in FIG. 1, the sensor chip 3 is electrically connected to the terminals 6 through bonding wires 16. A protective element (capacitor) 17 is provided between each adjacent two terminals 6. When a high voltage is applied from the terminal 6, the high voltage is grounded through the protective element 17.

With reference to FIG. 2, the optical lens 4 is arranged over the sensor chip (light sensing element) 3 and is used to guide the light entered the optical lens 4 toward the sensor chip 3. The optical lens 4 is made, for example, of a colored glass material or a resin material (translucent material) and is shaped into a bowl shape. The optical lens 4 is fitted around an outer peripheral portion of the holder 8 and is supported above the sensor chip 3 by the housing 2. The optical lens 4 has a recess 23 recessed in the center of the inner peripheral surface (lower surface) thereof. Because of the recess 23, the lens 4 can perform its function. The light is directed toward the sensor chip 3 through the recess 23 of the optical lens 4.

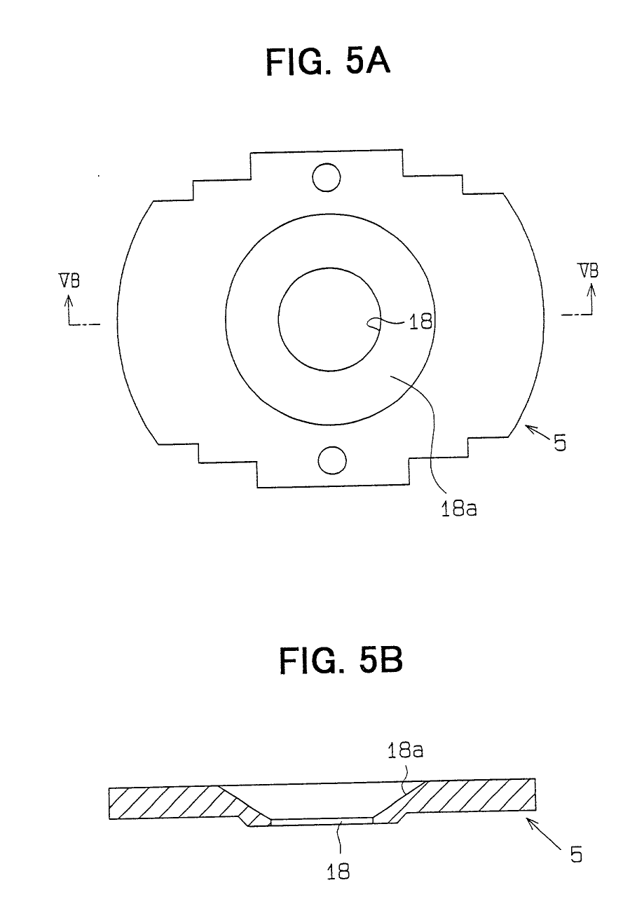

With reference to FIG. 2, the shading plate 5 acting as a shading member is positioned above the sensor chip (light sensing element) 3 and allows the light exited from the lens 4 to pass through a through hole (slit) 18 thereof toward the sensor chip 3. The shading plate 5 is supported on the top surface of the holder 8 in such a manner that the shading plate 5 covers the sensor chip 3. FIG. 5 shows details of the shading plate 5 to be placed on the top surface of the holder 8.

With reference to FIG. 5, the shading plate 5 is made of a nontransparent material. In this embodiment, the shading plate 5 is made of a resin material. However, it is possible to use any other material, such as a metal material, to form the shading plate 5. The through hole 18 of the shading plate 5 vertically penetrates through the center thereof and has a circular shape. On the top side of the shading plate 5 around the through hole 18, there is provided a tapered portion (sloped portion) 18a having an increasing diameter that increases from its lower end toward its top end. As shown in FIGS. 1 and 2, the shading plate 5 is mounted to the top surface of the holder 8 in such a manner that the center of the through hole 18 generally coincides with the center of the sensor chip 3 (light sensing portion 11). The light directed from the left side impinges on the right side of the sensor chip 3, and the light directed from the right side impinges on the left side of the sensor chip 3.

A shape and size of the opening of the recess 23 of the optical lens 4 are substantially the same as a shape and size of a top opening (more specifically, the opening located at the top end of the tapered portion 18a) of the through hole 18 of the shading plate 5. Furthermore, an outer peripheral edge of the opening of the recess 23 of the optical lens 4 is vertically substantially aligned with an outer peripheral edge of the top opening of the through hole 18 of the shading plate 5. Furthermore, the lower surface of the optical lens 4 is engaged with a top surface of the shading plate 5. That is, there is no clearance between the top surface of the shading plate 5 and the lower surface of the optical lens 4.

As shown in FIG. 2, the holder 8 includes a plate portion 19 that extends horizontally. The sensor chip 3 is bonded to the center of a top surface of the plate portion 19. A lateral wall 20 vertically extends from an outer peripheral edge of the top surface of the plate portion 19. The lateral wall 20 is cylindrical and extends around an installation area of the center chip 3 on the top surface of the plate portion 19. A potting material 21 is filled inside of the lateral wall 20 to cover the sensor chip 3 and the wires 16 (FIG. 1). Furthermore, a couple of shading plate support portions 22a, 22b are formed on a top surface of the lateral wall 20, as shown in FIG. 1. Each shading plate support portion 22a, 22b is flat and has a generally rectangular cross-section. These two shading plate support portions 22a, 22b are positioned on opposed sides of the sensor chip 3, respectively. Also, as shown in FIG. 2, a height H of each shading plate support portion 22a, 22b is higher than that of the lateral wall 20. The shading plate 5 is bonded to top surfaces of the shading plate support portions 22a, 22b.

As described above, the shading plate support portions 22a, 22b having the height H shown in FIG. 2 are formed on the top of the housing 2, and the shading plate 5 is supported by and is bonded to these shading plate support portions 22a, 22b. Thus, interference between the shading plate 5 and the housing 2 is effectively restrained.

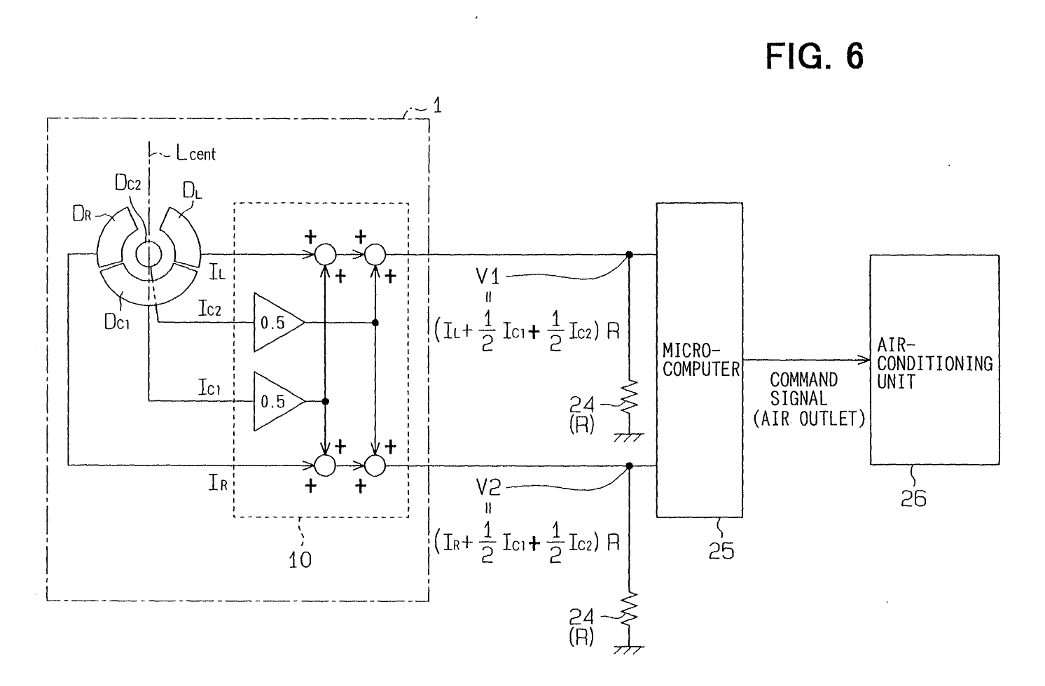

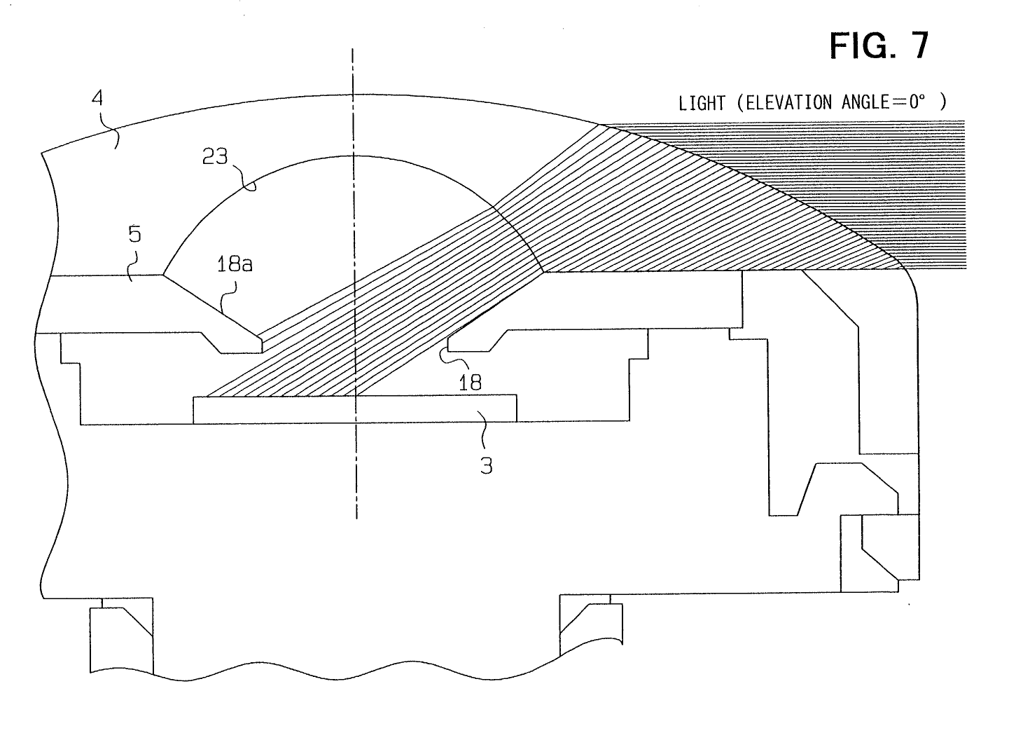

FIG. 6 shows an electrical arrangement of the automatic air conditioning system.

The signal processing circuit 10 is connected to the four photodiodes DR, DL, DC1, DC2. In the signal processing circuit 10, an output electrical current from the left-incident light sensing photodiode DL and one-half of an output electrical current from each central sensing photodiode DC1, DC2 are added together to produce an output current of a left-incident light signal (=IL+½×IC1+½×IC2). Then, the output current of the left-incident light signal is applied to a resistor 24 (resistance: R) for current to voltage conversion and is thereafter fed to a microcomputer 25. Also, an output electrical current from the right-incident light sensing photodiode DR and 0 one-half of an output electrical current from each central sensing photodiode DC1, DC2 are added together to produce an output current of a right-incident light signal (=IR+½×IC1+½×IC2). Then, the output current of the right-incident light signal is applied to another resistor 24 (resistance: R) for current to voltage conversion and is thereafter fed to a microcomputer 25. As a result, the left-incident light signal V1 is produced from the output of the left-incident light sensing photodiode DL and the outputs of the central sensing photodiodes DC1, DC2. The right-incident light signal V2 is produced from the output of the reft-incident light sensing photodiode DR and the outputs of the central sensing photodiodes DC1, DC2. Based on these signals V1, V2, an intensity of the sunlight and a sunlight incident side (driver's seat side or passenger' seat side), from which the sunlight is projected, are determined. More specifically, the amount of the projected sunlight is determined based on the total amount of the output (=V1+V2), and the sunlight incident side or direction of the sun is determined based on an output ratio (=V1/(V1+V2) or =V2/(V1+V2)).

The microcomputer 25 is connected to an air conditioning unit 26 which includes a blower, a cooler, a heater and the like and is mounted within an instrument panel of the vehicle. The microcomputer 25 determines the amount of the sunlight and the sunlight incident side (left or right) based on the above-described two signals V1, V2 and controls the air conditioning unit 26 based on the left-side light intensity and the right-side light intensity to increase the amount of air to be blown toward the sunlight incident side and decreases the temperature of the air to be blown toward the sunlight incident side in comparison to the other side, allowing independent control of the air conditioning at the left side and the right side of the passenger compartment.

An optical system of the sensor according to the present embodiment will be described with reference to FIG. 7.

The light entered the optical lens 4 is deflected therethrough toward the sensor chip 3 through the shading plate 5. That is, the light entered the surface (optical lens 4) of the sunlight sensor is deflected to change its optical path based on a refractive index and a material type of the lens 4 and is outputted from the lens 4 toward the sensor chip 3 through the through hole 18 of the shading plate 5. The light impinged on each photodiode DR, DL, DC1, DC2 (FIG. 3) is converted to an electrical signal and is outputted from the photodiode DR, DL, DC1, DC2.

The outer peripheral edge of the opening of the recess 23 of the optical lens 4 is vertically substantially aligned with the outer peripheral edge of the top opening of the through hole 18 of the shading plate 5. Thus, the optical path of the light passing from the recess 23 of the optical lens 4 through the through hole 18 of the shading plate 5, i.e., the optical path between the opening of the recess 23 of the optical lens 4 and the top opening of the through hole 18 of the shading plate 5 becomes the continuous unobstructed optical path. As a result, the light can be effectively guided to the sensor chip (light sensing element) 3. Furthermore, even when the elevation angle of the sun is relatively low (e.g., zero degrees), the sunlight can be effectively sensed. Thus, the sunlight sensor according to the present embodiment is effective for sensing the direction of the sun, satisfying the demand for the sunlight sensor used in the zone air conditioning.

As shown in FIG. 7, even at the low elevation angle of the sun, the sunlight is effectively guided to the light sensing element, so that the output of the sensor is improved to allow more accurate sensing of the sunlight. That is, the more accurate sensing of the sunlight allows achievement of a compact sunlight sensor.

Furthermore, if the outer peripheral edge of the top opening of the through hole 18 of the shading plate 5 is located radially inward of the outer peripheral edge of the opening of the recess 23 of the optical lens 4, the sunlight at the low elevation angle of the sun cannot be effectively guided to the through hole 18 of the shading plate 5 from the recess 23 of the optical lens 4, so that the output of the light sensing element is reduced when the sunlight is sensed with the light sensing element. On the other hand, if the outer peripheral edge of the top opening of the through hole 18 of the shading plate 5 is located radially outward of the outer peripheral edge of the opening of the recess 23 of the optical lens 4, the sunlight is dispersed when the sunlight is guided from the recess 23 of the optical lens 4 toward the through hole 18 of the shading plate 5. Thus, unnecessary light is sensed with the light sensing element, causing undesirable side effects of reduced accuracy.

The shape and size of the opening of the recess 23 of the optical lens 4 are substantially the same as the shape and size of the top opening of the through hole 18 of the shading plate 5. Furthermore, the lower surface of the optical lens 4 is engaged with the top surface of the shading plate 5. Thus, the dispersion of the light is substantially restrained (restraining substantial influence of the dispersion of the light).

In the above-described embodiment, the photodiodes are used to constitute the light sensing element. In place of the photodiodes, phototransistors can be used.

Additional advantages and modifications will readily occur to those skilled in the art. The invention in its broader terms is therefore, not limited to the specific details, representative apparatus, and illustrative examples shown and described.

What is claimed is:

1. A photosensor comprising:
a housing;
a light sensing element arranged on a top surface of said housing;
an optical lens arranged above said light sensing element, said optical lens including a recess having an opening in a lower surface of said optical lens, said optical lens guiding light entered therein toward said light sensing element through said recess; and
a shading member arranged between said light sensing element and said optical lens, said shading member having a through hole penetrating therethrough, said light exited from said optical lens is guided through said through hole of said shading member toward said light sensing element, wherein an outer peripheral edge of said opening of said recess of said optical lens is vertically substantially aligned with an outer peripheral edge of a top end opening of said through hole of said shading member.

2. A photosensor according to claim 1, wherein a shape and size of said opening of said recess of said optical lens are substantially the same as a shape and size of said top end opening of said through hole of said shading member.

3. A photosensor according to claim 2, wherein said lower surface of said optical lens is engaged with a top surface of said shading member.

4. A photosensor according to claim 1, wherein said through hole of said shading member includes a sloped portion at said top end opening of said shading member, said sloped portion having an increasing diameter that increases from its lower end toward its top end.
